(19) United States
(12) Patent Application Publication
(10) Pub. No.: US 2010/0242686 A1
(43) Pub. Date: Sep. 30, 2010

(54) REPLACEABLE WRENCH JAWS

(76) Inventor: Colin Graeme Gower, North Shore City (NZ)

Correspondence Address: Colin Gower, P O Box 28532, Santa Fe, NM, 87592, US

(21) Appl. No.: 12/746,161

(22) PCT Filed: Dec. 5, 2008
(86) PCT No.: PCT/NZ2008/000328

§ 371 Date: Jun. 3, 2010

(30) Foreign Application Priority Data
Dec. 5, 2007 (NZ) 560893

(51) Int. Cl. B25B 13/28; B25B 13/58

(52) U.S. Cl. 81/100; 81/185.1

(57) ABSTRACT

A tool for gripping and manipulating components such as pipes and nuts; the tool having gripping surfaces provided on removable inserts in the head and jaw such that the gripping surfaces can be replaced if worn, or interchanged, according to need. In particular the invention provides a self-adjusting wrench and a plurality of replaceable or interchangeable gripping inserts for use with the wrench.

### FIELD

This invention relates to wrenches and other gripping and turning apparatus, with particular application to self-adjusting wrenches.

### BACKGROUND

A wide variety of wrenches, spanners, pliers and other devices are known for gripping and turning nuts, bolts, pipe connectors and other screw-threaded connectors. These may be sized to fit a particular size of connector, or may be adjustable to fit a range of connectors. In many circumstances an adjustable wrench is preferred over a spanner of a specific size, not only because a single tool can be used for a wider range of tasks, but also because when a connector has become worn, the wrench can be tightened further to grip it more securely.

One known type of adjustable wrench has a pivotally mounted jaw with a light spring-bias into a closed position, arranged to pivot past an eccentrically curved opposed gripping surface on the head of the tool. Such a wrench is shown in U.S. Pat. No. 6,971,288 B2 (Chen Wei). The inventor calls this the “Super wrench”. As the jaw is pivoted one way or the other, gripping surfaces on the jaw are brought closer to or further away from the eccentrically curved gripping surface, giving a continuous range of gripping apertures between a given maximum and minimum. This type of wrench has an advantage in that the spring biasing automatically engages the tool around a connector of any size between the minimum and the maximum, but with a compressive force equal only to the strength of the spring. Rotational force to turn a connector in one direction causes the wrench to tighten, such that the more difficult a connector is to turn, the more firmly the wrench grips.

Conversely, when the wrench is turned in the opposite direction it automatically releases, allowing a ratcheting action if desired.

### PROBLEM TO BE SOLVED

Particularly with adjustable wrenches, it is generally necessary for the device to clamp tightly onto the connector so as to provide sufficient frictional contact with the connector to turn it. This creates wear on the bearing surfaces of the wrench itself, and in particular if the wrench has serrated or otherwise roughened surfaces to provide better grip, these surfaces can rapidly be worn smooth and lose their effectiveness. In particular in the oil industry where large-scale 60″ wrenches and spanners are used to tighten and loosen hardened steel drill components, often being hammered into engagement and/or rotated by hammering, the wear on tools and in particular their gripping teeth can be so severe as to require replacing them almost daily. The applied force inherently increases the force applied to the teeth.

At another extreme, tools used on fuel lines for aircraft and the like must be used with a minimum of compressive force and must not gouge or scrape the line, to avoid damaging the line. Because the lines carry fuel under very high pressure, even a small discontinuity in the line caused by previous tool damage can create a risk of the line bursting.

### OBJECT

It is an object of this invention to provide an improved gripping and turning means, or at least to provide the public with a useful choice.

### STATEMENT OF INVENTION

In a first broad aspect the invention provides a tool including a handle by which torque can be produced, and a head by which torque can be applied, the head including opposed gripping surfaces on a support structure, wherein the gripping surfaces are formed on detachable inserts shaped and arranged to engage into the support structure.

Preferably the tool comprises an adjustable wrench.

Preferably the tool comprises a self-adjusting wrench having a pivotally mounted jaw bearing at least one gripping surface, and curved bearing surface on the head opposed to the gripping surface(s) on the jaw, the curved bearing surface being eccentrically curved with regard to the pivot axis of the jaw.

Preferably the curved bearing surface forms an arc about a centre offset relative to the pivot axis of the jaw.

Alternatively the curved bearing surface follows a section of a spiral.

Preferably the jaw is spring-biased towards a closed configuration.

Alternatively the tool comprises a spanner.

Alternatively the tool comprises pliers.

Preferably the inserts are keyed into the support structure with one or more engagement elements having a surface bearing against a surface of the support structure in a direction of rotational force of the tool in use.

Preferably the inserts are keyed into the support structure with a dovetail joint.

Preferably the inserts include a locking pin or screw.

Preferably the inserts are formed from hardened steel.

Preferably the inserts are formed from a material having a hardness on the Rockwell scale of greater than 50 HRC.

Alternatively the inserts are formed from brass, or a material having a hardness on the Rockwell scale of less than 80 HRC.

For applications such as fuel lines, the inserts are formed from a plastic material incapable of cutting into the fuel line piping or nuts. Actual teeth may be absent: a property of materials may be used to provide grip.

In another aspect the invention provides an adjustable wrench having a set of interchangeable gripping surfaces.

These and other aspects of the invention may be made apparent in the following description of preferred embodiments, with reference to the accompanying drawings.

### PREFERRED EMBODIMENT

The description of the invention to be provided herein is given purely by way of example and is not to be taken in any way as limiting the scope or extent of the invention.

Throughout this specification unless the text requires otherwise, the word “comprise” and variations such as “comprising” or “comprises” will be understood to imply the inclusion of a stated integer or step or group of integers or steps but not the exclusion of any other integer or step or group of integers or steps.

### DRAWINGS

FIG. 1: illustrates a self-adjusting wrench of this invention in side view.

FIG. 2: shows detail of the wrench of FIG. 1 in side view and partial section.

FIGS. 3 and 4: shows alternative embodiments of the invention.

FIG. 5 shows a more recent version of the invention in side view.

FIGS. 6 and 7 show two example types of replacement jaws.

It should be realized that alternative means for fixing these jaws to the wrench or other tool may be subjected to considerable forces during use and may in practice be stronger than those drawn and described here.

Two main reasons for providing a wrench with replaceable jaws are (1) to provide appropriate jaws for different jobs, and (2) to provide replacements for jaws in which the teeth have lost their grip as a result of inevitable damage during use.

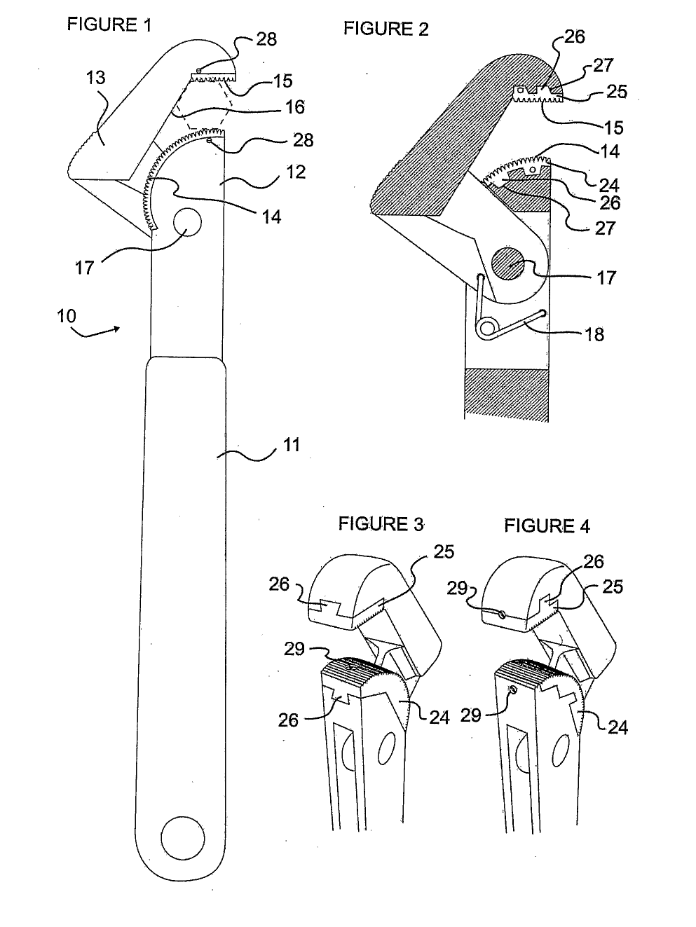

In a preferred form as illustrated in FIG. 1, the invention provides a self-adjusting wrench 10 having a handle 11, a head 12 and a pivotally mounted jaw 13. The head 12 includes a curved gripping face 14, opposed to an inner gripping face 15 on the jaw 13. The gripping face 15 is preferably arranged at 60° to a second inner face 16 of the jaw, so that a hexagonal bolt head, nut or other rotary connector can seat into the angle between the two faces. The curved gripping face 14 on the head is preferably a section of a spiral, or an arc around a centre point which is offset relative to the pivot point 17 of the jaw, so that the distance between the surface of the gripping face 14 and the pivot point 17 increases in a smooth gradient from a nearest point 14a towards the base of the jaw 13 to a furthest point 14b at the mouth. The distance from the pivot point to the gripping face 15 on the jaw remains constant, so the gap between the curved gripping face 14 and the opposed gripping face 15 on the jaw accordingly varies as the jaw is opened or closed, between a narrowest configuration when the jaw is closed (as shown in FIG. 1) and a widest configuration when the jaw is fully opened. The jaw is biased towards the closed configuration by a spring 18 (seen in FIG. 2). Both the gripping surfaces 14 and 15 (and optionally also the second inner face 16 of the jaw) are preferably serrated, grooved or otherwise provided with a profile which can frictionally engage with a surface to prevent or reduce sliding movement of one across the other. Since this type of wrench has a preferred direction of rotation, the serration preferably has a sawtooth profile so that the teeth tend to become more embedded during the “powered stroke”, to provide a better grip than that of a symmetrical serration.

In a first version shown particularly in FIG. 2, the gripping surfaces 14 and 15 are provided on keyed inserts 24 and 25 respectively. In the embodiment shown in FIGS. 1 and 2, the inserts have two or more lugs 26 which key into sockets 27 in the head and jaw of the tool. When in use, the gripping surfaces of the tool 10 are of course subjected to a strong sideways force. The lugs 26 provide areas of flat surface-to-surface contact against the wall of the socket 27 in which they are seated, and prevent movement of the inserts 24 and 25 relative to the head and jaw of the tool. The inserts are preferably held in place with a small set screw 28 although other alternatives such as a spring-loaded rod operating within a tube may be arranged.

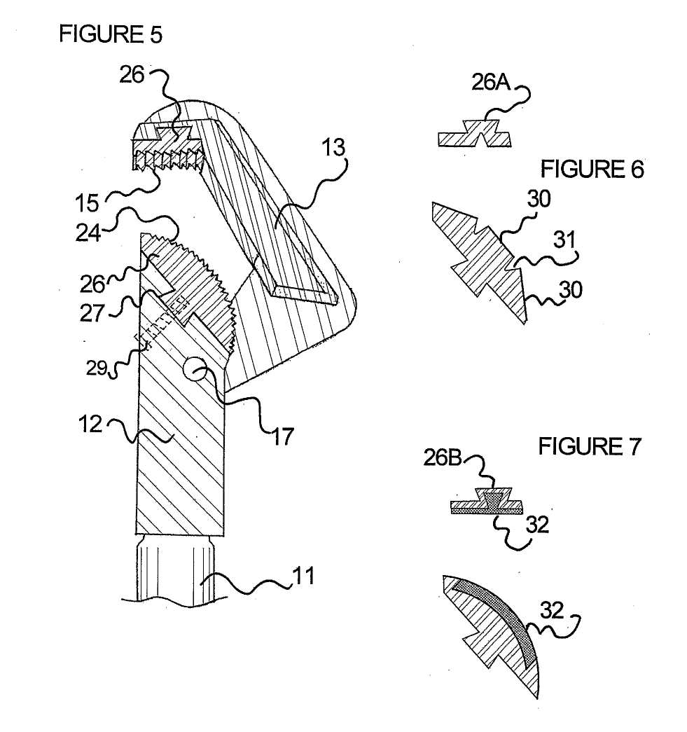

In FIG. 5, which is a drawing of a production version of the invention, use is made of dovetail type joints as shown herein, where the insert typically bears a male portion of the joint and the end surface of the tool such as the head 12 bears a corresponding female portion 27. Inverting the sex is also possible, while remaining within the scope of the invention. The preferred dovetail type joints can be disassembled only by movement of the respective parts along the length of the joint. They cannot be pulled directly apart. The direction of movement of the joint should be transverse to the direction of loads exerted on the jaws when the tool is turned around a component such as a nut or a threaded pipe. It will be appreciated that other mating configurations may also have a similar attribute, but a dovetail illustrates the principle of the invention. The joint should be easy to disassemble even after the tool has been subjected to forces beyond its design limit, which is when a new insert is likely to be needed. Use by drillers on oil rigs and the like must be allowed for. Incidentally the version shown in FIG. 3, with the dovetail extended along the length of the insert and in the same direction as expected forces when in use, is not recommended because all loads will be concentrated upon a locking pin or screw (29 in FIG. 3, 4 or 5). And if that version was used with a tapered (along the length) kind of joint instead of one with parallel sides then it would become locked in place. As shown in FIGS. 3 to 7, the specific form of the insert may vary considerably within the scope of the invention. In particular, the inserts may be keyed into the head and jaw of the tool in a variety of different ways. Rather than comprising lugs which plug into sockets, the engagement means may comprise a sliding dovetail joint as shown in FIG. 3, with a locking screw 29 passing through the insert into the supporting structure to hold it in place. Preferably the head of the screw 29 is rebated into the gripping surface so as not to interfere with the gripping function of the tool. Means to clamp the jaws in place should take account of the forces applied to the inserts during use.

Alternatively as shown in FIG. 4 the inserts may slide into place in the tool from the side, and be fixed in place by a screw 29 from the end. This arrangement means that the sliding movement of the insert is orthogonal to the direction of forces applied to the gripping surfaces in use, and the side of the lug is pressed in surface-to-surface contact with the side wall of the rebate in which it slides when the tool is in use. The profile of the lug can be shaped to provide strong bracing surfaces in the direction of force.

A variety of other changes and modifications might also be made within the general spirit and scope of the invention.

While the invention is preferably applied to a self-adjusting wrench as described above, it might also be applied, possibly with some modification, to other wrenches, vice grips, spanners, pliers or other such tools. Similarly, while the example illustrated above shows an 8″ wrench, the invention could equally be applied to tools of any size with adjustments of scale to the proportions of parts as required.

The inserts 24 and 25 can be hardened, preferably to a Rockwell hardness rating of 50 HRC or more, to resist wear when engaged on hardened connectors in drilling equipment or the like, which might typically have a hardness of 52 HRC. Alternatively just the teeth or serrations on the gripping surface may be hardened, or even the upper part of the teeth. Whereas hardening the entire tool 10 to this degree is expensive and makes the tool brittle—such that it might crack if hammered to turn a particularly stubborn fastener—the relatively small inserts can be hardened easily and inexpensively. The gripping parts of the tool are less likely to be subjected to sharp impacts than the shaft or handle, so are unlikely to be damaged.

Alternatively, the inserts 24 and 25 could be formed from brass, soft steel, a plastics material, or other relatively soft material. Such a material can allow the tool to grip onto a connector without damaging it, and may also allow the gripping surfaces to deform slightly into more complete contact with the connector under rotational force. This can improve the grip of the tool and also spread the force more evenly across the surface of the connector to avoid damage to the connector.

FIG. 6 shows a variant of the inserts in which the gripping surface is a flat or a series of flat facets 30. Optionally each of these are separated by a groove 31 cut into the surface of the face, and preferably the floor of the groove is rounded, not provided as a sharp corner, in order to minimize development and propagation of cracks within the usually hardened insert material. When in use, a nut bearing a series of flat surfaces may be gripped by means of a flat-to-flat contact between two inserts in an adjustable wrench according to the invention. Alternatively, the corners between the flat surfaces may be caught within the grooves 31 in between two facing inserts; one mounted on the head 12 of the wrench and one mounted on the adjustable jaw 13.

Particularly in order to operate on easily damaged surfaces, plastics inserts 32 within the inserts 26 may be provided, as shown in FIG. 7, where 32 represents a plastics insert that may be co-moulded into empty wrench inserts. Alternatively, the entire insert may be moulded in a suitable plastics material. Typical applications for plastics inserts include plumbing, when visible bathroom fittings must not be damaged by forceful application of a wrench bearing hard, sharp teeth. In the airplane engineering field there is also a strong requirement not to distort a component in such a way that degradation may follow, such as radiating from an impressed groove. Therefore inserts may be made from compatible materials such as brass or an aluminium alloy, Entire inserts capable of withstanding these loads may be moulded or machined from durable plastics or blends or alloys thereof, including selected polyamides e.g. “Nylons” ™, poly vinyl chloride (PVC), polyethylene terephthalate (PET) and the like, a selection apparent to one skilled in the art. It is not easy to confidently nominate a preferred plastics material in this quickly developing area.

It will be appreciated that sets of different inserts 24 and 25 could be provided for the tool 10, formed from different materials and/or having different gripping surfaces, which can be interchanged to suit the tool to different purposes by undoing the set screw 28 and replacing one pair of inserts with another.

### VARIATIONS

A proposed form of presentation of these wrenches and a choice of insert teeth for each is as a set of different sizes, such as handle lengths of from 6 inches (150 mm) to 12 inches (300 mm). For a drilling type application it may be preferable to provide a set of two or three 18 inch (600 mm) to 36 inch (600 mm) wrenches.

The same idea; that of an insert which may be replaced, may be applied to other tools such as vice grips, fixed spanners, adjustable spanners, or pliers. The inventor believes that inserts are likely to be useful for tools wherein the grip by the tool on to a component becomes tighter as the grip applied is increased, particularly where the tool configuration renders that increase an automatic result.

Finally it will be understood that the scope of this invention as described and/or illustrated herein is not limited to the specified embodiments. Those of skill will appreciate that various modifications, additions, known equivalents, and substitutions are possible without departing from the scope and spirit of the invention as set forth in the following claims.

I claim:

1) A tool for gripping and applying a torque to a component; the tool including a handle by means of which torque can be produced, and a head by which torque can be applied, the head including a a support structure supporting a set of two complementary opposed gripping surfaces; the gripping surfaces each configured with a secondary gripping structure having a gripping axis parallel with an axis of rotation of the component when the tool is in use; wherein the gripping surfaces and secondary gripping structures are formed upon detachable and replaceable inserts shaped on a first face of each insert in order to fit against and engage with the support structure, and to grip the component against an opposite face of each insert by a pressure applied by the tool between a first member of the set and a second member of the set.

2) A tool as claimed in claim 1, wherein the tool comprises a self-adjusting wrench having a pivotally mounted jaw bearing at least one gripping surface, and a curved bearing surface on the head opposed to the gripping surface(s) on the jaw, the curved bearing surface being eccentrically curved with regard to the pivot axis of the jaw, and the jaw is spring-biased towards a closed configuration.

3) A self-adjusting wrench as claimed in claim 2, wherein each insert is provided with one or more engagement elements capable during use of retaining the inset in place upon the support structure of the tool until a user chooses to replace the insert; each engagement element being oriented with an axis parallel to an axis of rotation of the component as caused by the tool when the tool is in use; each engagement means including a locking means so that the insert is held in place until it is deliberately released by a user.

4) A self-adjusting wrench as claimed in claim 3, wherein the curved bearing surface forms an arc about a centre offset relative to the pivot axis of the jaw.

5) A self-adjusting wrench as claimed in claim 3, wherein the curved bearing surface follows a section of a spiral.

6) A self-adjusting wrench as claimed in claim 3, wherein the sets of inserts bearing complementary opposed gripping surfaces each bearing a secondary structure are selected from a range including:
a) hardened steel inserts, each insert bearing a secondary structure in the form of a series of close-together sharpened ridge-like teeth and having a HRC of over 50;
b) inserts bearing a secondary structure in the form of a series of broad, flat-topped teeth, wherein each tooth is separated from neighbouring teeth by a groove and has a HRC of over 50; the insert allowing a polygonal component (nut) to be gripped either by opposing flat tops of the teeth or gripped by corners of the components within opposing grooves;
c) inserts having a series of engagement means comprising broad, flat-topped teeth, wherein each tooth is separated from neighbouring teeth by a groove and has a HRC corresponding to that of a brass;
d) inserts having a series of engagement means comprising broad, flat-topped teeth, wherein each tooth is separated from neighbouring teeth by a groove and has a HRC corresponding to that of a plastics material resistant to solvents and resistant to damage or distortion during use, selected from a range of plastics including polyamides, polyethylene terephthalate, polyvinyl chloride with plasticizer, and alloys or blends thereof, so that when in use the tool presents a relatively soft gripping surface to a surface of the components and does not damage the component;

7) A tool as claimed in claim 1, wherein the tool having replaceable inserts comprises a spanner.

8) A tool as claimed in claim 1, wherein the tool the tool having replaceable inserts comprises pliers.
